(19) United States
(12) Patent Application Publication
(10) Pub. No.: US 2014/0167555 A1
(43) Pub. Date: Jun. 19, 2014

(54) CARBON FIBER STATOR AND ROTOR FOR AN ELECTRIC MOTOR

(71) Applicant: Eric Mims, Henderson, NV (US)

(72) Inventor: Eric Mims, Henderson, NV (US)

(21) Appl. No.: 14/014,205

(22) Filed: Aug. 29, 2013

Related U.S. Application Data
(63) Continuation-in-part of application No. 13/594,403, filed on Aug. 24, 2012.
Application No. 13/594,403 is a continuation-in-part of application No. 12/426,760, filed on Apr. 20, 2009, now abandoned.

(51) Int. Cl. H02K 1/16; H02K 15/00; H02K 1/22

(52) U.S. Cl. CPC H02K 1/16; H02K 1/22; H02K 15/00
USPC 310/216.001; 29/596

(57) ABSTRACT

An electric motor includes a carbon fiber stator core having a plurality of longitudinal slots and poles arranged on an interior surface thereof, the stator core having a hollow central portion. A thin metallic sleeve is inserted into the stator core so as to mate with an interior surface of the stator core. An outer surface of the metallic sleeve corresponds in shape to the interior surface of the stator core. A carbon fiber rotor is suspended within the hollow central portion of the stator core. The carbon fiber rotor further includes inserts formed of ferromagnetic metals or permanent magnets.

### PRIORITY CLAIM

This is a continuation-in-part of U.S. patent application Ser. No. 13/594,403, filed on Aug. 24, 2012, which is a continuation-in-part of U.S. patent application Ser. No. 12/426,760, filed Apr. 20, 2009, which claims benefit of U.S. Provisional patent application Ser. No. ______, filed Apr. ______, 2008, to inventor Eric Alan Mims entitled “Tri-Power Systems,” each of which is hereby incorporated herein by reference in its entirety.

### BACKGROUND

1. Field of the Invention

The present invention relates generally to electric motors. More particularly, the present invention relates to the use of carbon fiber in the construction of an electric motor's stator core and rotor.

2. Related Art

In the construction of electric motors, the stators are typically formed by taking a plurality of thin iron sheets and cutting them into the shape of the stator. These thin sheets are then stacked on top of each other, braced, welded, and then cured to form the stator. After the stator has cooled, thin sheets of fiber paper are inserted into the gaps and copper windings are placed inside the cavities of the along the inside surface of the stator to form the magnetic core. After assembly the entire stator is cured with dielectric material to insure a uniform magnetic flux.

The rotor typically includes a heavy balanced shaft which is provided with a plurality of alternating magnets or ferromagnetic rods around the shaft that rotate in close proximity to the stator in response to the magnetic field generated by alternating currents through the copper windings within the gaps or around the poles of the stator.

The stator core and rotor are typically designed at ⅔ radii in order to allow heat dissipation and reduce the resistance caused by turbulent air flow in the space between the rotor and the stator core. The inventor has several designs that repair the design flaws and smooth out the turbulence inside the motor system.

It is not the inventor's aim to describe the construction of current electric motor, but to point out the flaws of said motors and the inventor's designs to fix said problems.

### SUMMARY OF THE INVENTION

It has been recognized that it would be advantageous to develop a lightweight stator and rotor configuration for use in an electric motor.

The invention provides an apparatus by which the stator core can be formed of a carbon fiber mesh and a metallic sleeve introduced into the interior of the carbon fiber stator core to provide a metallic surface by which the wire windings may produce the magnetic field for driving the rotor.

Additionally the invention provides a rotor having a carbon fiber core which reduces the inertial loads on the motor and allows for increased efficiency by the electric motor.

### BRIEF DESCRIPTION OF THE DRAWINGS

Additional features and advantages of the invention will be apparent from the detailed description which follows, taken in conjunction with the accompanying drawings, which together illustrate, by way of example, features of the invention; and, wherein:

FIGS. 1A-C illustrate a t-bar shim and an embodiment illustrating the use of a t-bar shim to smooth the interior of a stator;

FIGS. 2A-B illustrate how an alternative embodiment of the t-bar shim can be used in conjunction with a stator slot;

FIGS. 3A-B illustrate cross sectional views of a permanent magnet motor and an induction motor, respectively, each utilizing carbon fiber construction for the stator core;

FIGS. 4A-B illustrate a radial cross sectional views of rotors with respect to a permanent magnet electric motor and an induction type electric motor;

FIG. 5 illustrates a radial cross sectional view of a cutting tool having a negative area of a desired stator core;

FIG. 6 illustrates a radial cross sectional view of a metallic sleeve for use with a stator having a carbon fiber construction;

FIG. 7 illustrates a flow chart representing method for fabricating a stator core in accordance with one embodiment of the present invention; and

FIG. 8 illustrates a flow chart representing one exemplary method for fabricating a stator core in accordance with another embodiment of the present invention.

Reference will now be made to the exemplary embodiments illustrated, and specific language will be used herein to describe the same. It will nevertheless be understood that no limitation of the scope of the invention is thereby intended.

### DETAILED DESCRIPTION

Before the present invention is disclosed and described, it is to be understood that this invention is not limited to the particular structures, process steps, or materials disclosed herein, but is extended to equivalents thereof as would be recognized by those of ordinarily skilled in the relevant arts. It should also be understood that terminology employed herein is used for the purpose of describing particular embodiments only and is not intended to be limiting.

It must be noted that, as used in this specification and the appended claims, the singular forms “a” and “the” can include plural referents, unless the context clearly dictates otherwise. Thus, for example, reference to an “insert” can include reference to one or more of such inserts.

### DEFINITIONS

In describing and claiming the present invention, the following terminology will be used in accordance with the definitions set forth below.

Relative directional terms, such as “upper,” “lower,” “top,” bottom,” etc., are used herein to aid in describing various features of the present systems, methods and techniques. It is to be understood that such terms are generally used in a manner consistent with the understanding one of ordinary skill in the art would have of such systems. Such terms should not, however, be construed to limit the present invention.

As used herein, the term “substantially” refers to the complete, or nearly complete, extent or degree of an action, characteristic, property, state, structure, item, or result. As an arbitrary example, an object that is “substantially” enclosed would mean that the object is either completely enclosed or nearly completely enclosed. The exact allowable degree of deviation from absolute completeness may in some cases depend on the specific context. However, generally speaking the nearness of completion will be so as to have the same overall result as if absolute and total completion were obtained.

The use of “substantially” is equally applicable when used in a negative connotation to refer to the complete or near complete lack of an action, characteristic, property, state, structure, item, or result. As another arbitrary example, a composition that is “substantially free of” particles would either completely lack particles, or so nearly completely lack particles that the effect would be the same as if it completely lacked particles. In other words, a composition that is “substantially free of” an ingredient or element may still actually contain such item as long as there is no measurable effect thereof.

As used herein, the term “about” is used to provide flexibility to a numerical range endpoint by providing that a given value may be “a little above” or “a little below” the endpoint.

Distances, forces, weights, amounts, and other numerical data may be expressed or presented herein in a range format. It is to be understood that such a range format is used merely for convenience and brevity and thus should be interpreted flexibly to include not only the numerical values explicitly recited as the limits of the range, but also to include all the individual numerical values or sub-ranges encompassed within that range as if each numerical value and sub-range is explicitly recited.

As an illustration, a numerical range of “about 1 inch to about 5 inches” should be interpreted to include not only the explicitly recited values of about 1 inch to about 5 inches, but also include individual values and sub-ranges within the indicated range. Thus, included in this numerical range are individual values such as 2, 3, and 4 and sub-ranges such as from 1-3, from 2-4, and from 3-5, etc.

This same principle applies to ranges reciting only one numerical value and should apply regardless of the breadth of the range or the characteristics being described.

Invention

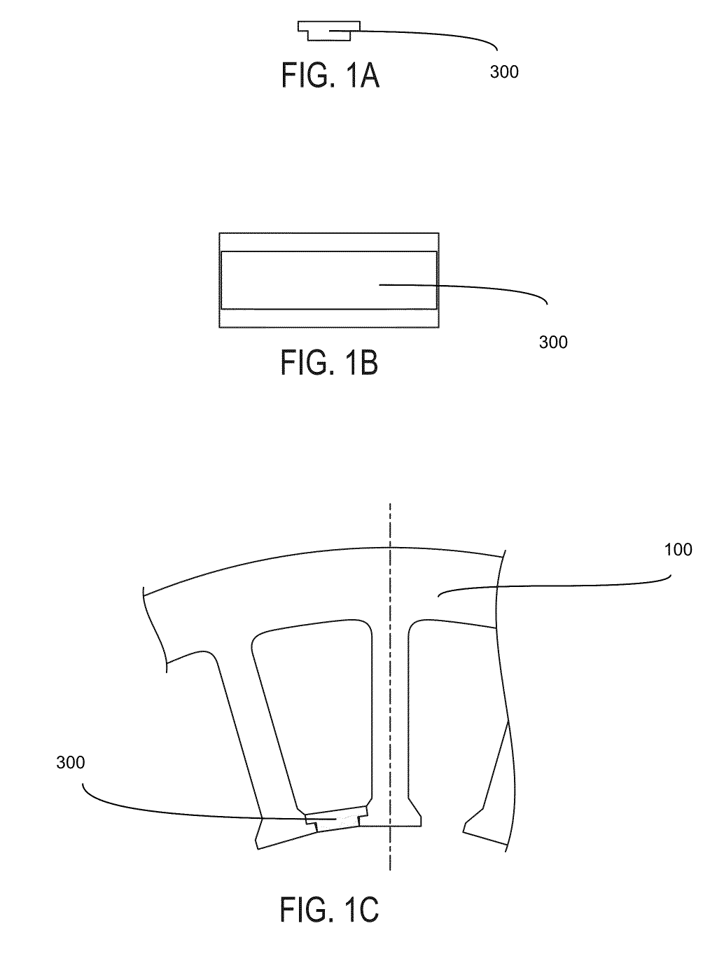

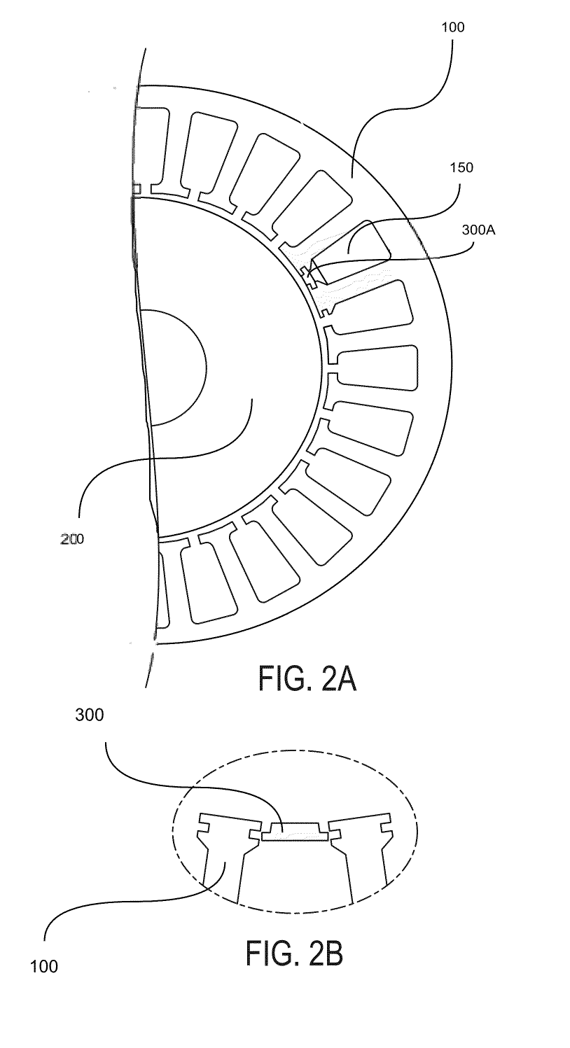

A system in accordance with an embodiment of the invention is illustrated generally in FIGS. 1A-C. Referring specifically to FIGS. 1A-C and FIGS. 2A-B, in one aspect of the invention a number of t-bars 300 may be inserted into the small gap between the copper wiring 150 and the inner surface of a stator core 100 in order to smooth the stator surface between the rotor 200 and the stator core 100. The t-bars can be formed in a variety of configurations, including generally flat, rectangular cross-section bars, or in the configuration illustrated in the figures. The term “t-bar” is not to be construed to limit the geometry of the inserts taught herein.

FIG. 1A illustrates an end view of one of the t-bars 300. FIG. 1B illustrates a top view of one of these t-bars. FIG. 1C illustrates an embodiment of the invention wherein the stator slots may be modified to accept flanges of the t-bars 300. By inserting these t-bars 300, the inner surface of the stator 100 is rendered smooth, rather than having a series of steps or slots corresponding to each slot of the stator 100. By eliminating the steps or slots in the stator near where the rotor rotates, air turbulence can be reduced and the rotor can rotate much more smoothly. FIG. 2A illustrates another embodiment of the t-bar 300A with corresponding flange cutouts in the stator core slots.

By applying a T-bar in accordance with one of the previous embodiments, the inner surface of the stator 100 is rendered smooth which facilitates in a significant reduction in the amount of turbulent air flow between the stator core 100 and the rotor 200. A reduction in turbulent air flow results in smoother operation by reducing the turbulent wind resistance as the rotor spins at increasingly high speeds. Further, by reducing the resistance caused by turbulent air flow the efficiency and the power of the motor can be increased. Wobble and off-center rotation of the rotor is also greatly reduced.

Additionally, this smooth surface allows for the rotor 200 to be larger and have a tighter fit between the rotor 200 and the inside diameter of the stator core 100. The increased radius of the rotor 200 causes the surface area of the rotor 200 in close proximity to the stator core 100 to increase as well. This surface area in close proximity to the stator core is referred to as the “swept area”. A larger swept area during operation has an effect of increasing the power output of the motor because it results in a larger surface area being subjected to the magnetic field caused by the electricity passing through the copper wiring 150, and thus exerts a larger torque on the rotor 200.

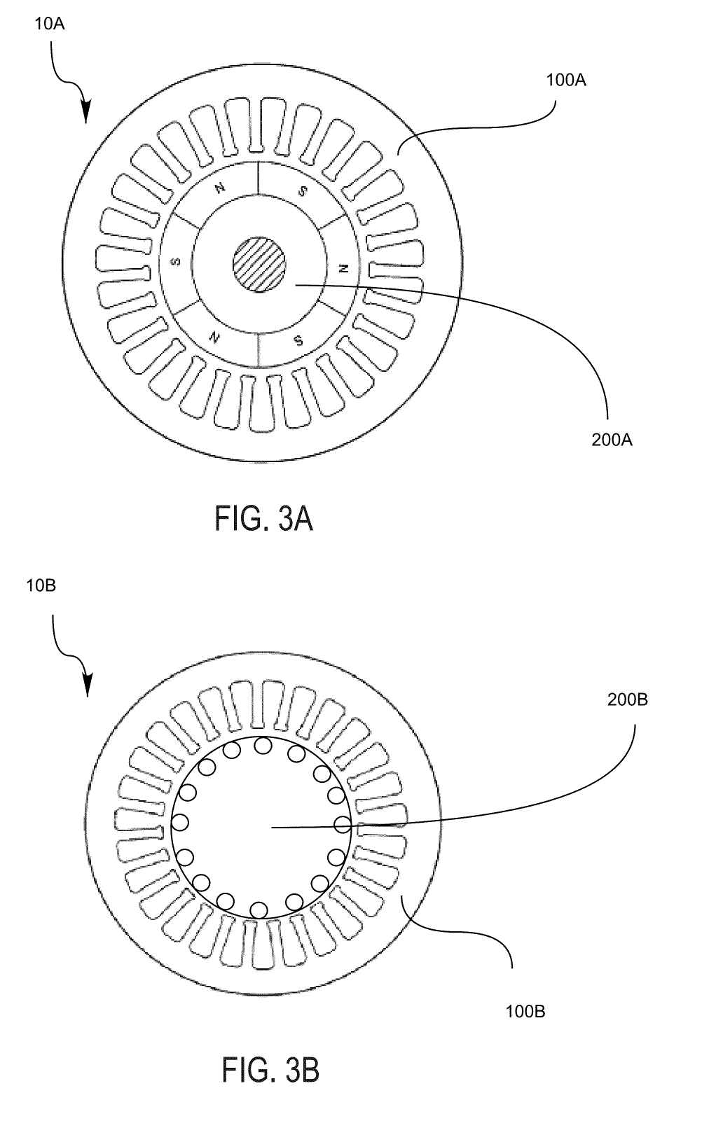

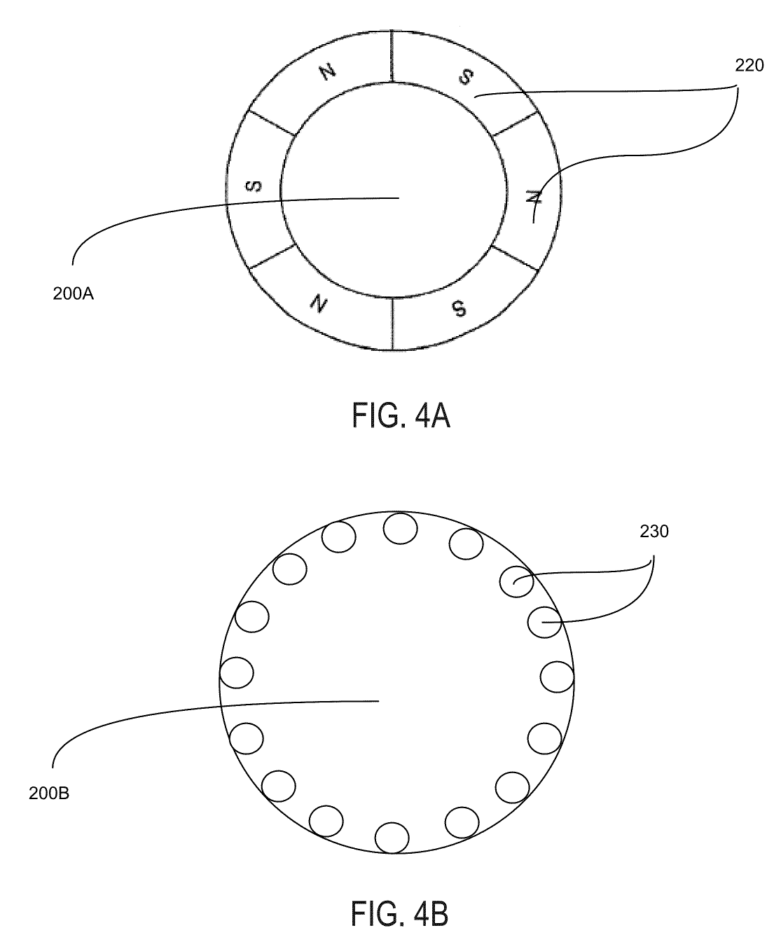

With reference to FIGS. 3A-B and FIGS. 4 A-B, shown are two types of electric motors 10A and 10B and their corresponding rotors 200A and 200B respectively. In this aspect, the first motor 10A is a permanent magnet motor, and the second motor 10B is an induction motor.

These motors 10A and 10B represent an additional aspect of the present invention which resides in the use of carbon fiber in the construction of the stator. Carbon fiber is a known light structural component, however one less commonly known attribute of carbon fiber is that it may also serve as a vessel for carrying an electromagnetic charge, or in the case of an electric motor, transferring an electromagnetic field. Despite this, however, carbon has yet to be utilized in the fabrication of rotors and stator cores. Therefore, Applicant has invented a method by which carbon fiber can be utilized in the formation of the rotor and the stator core.

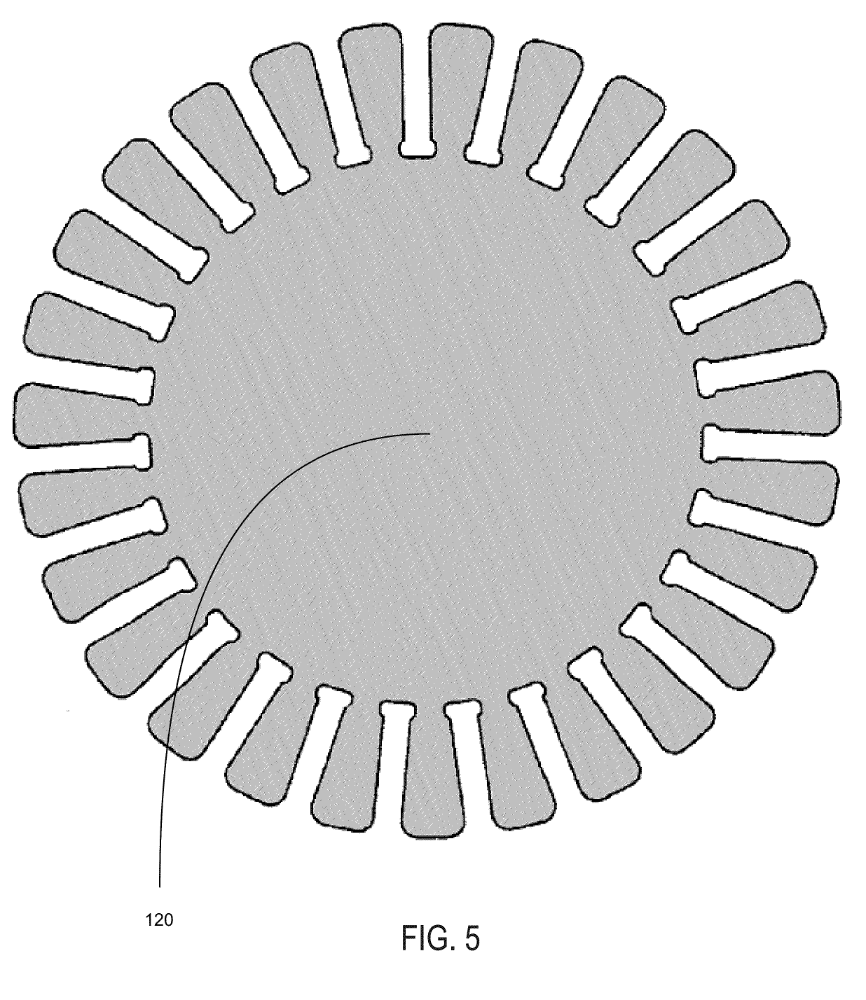

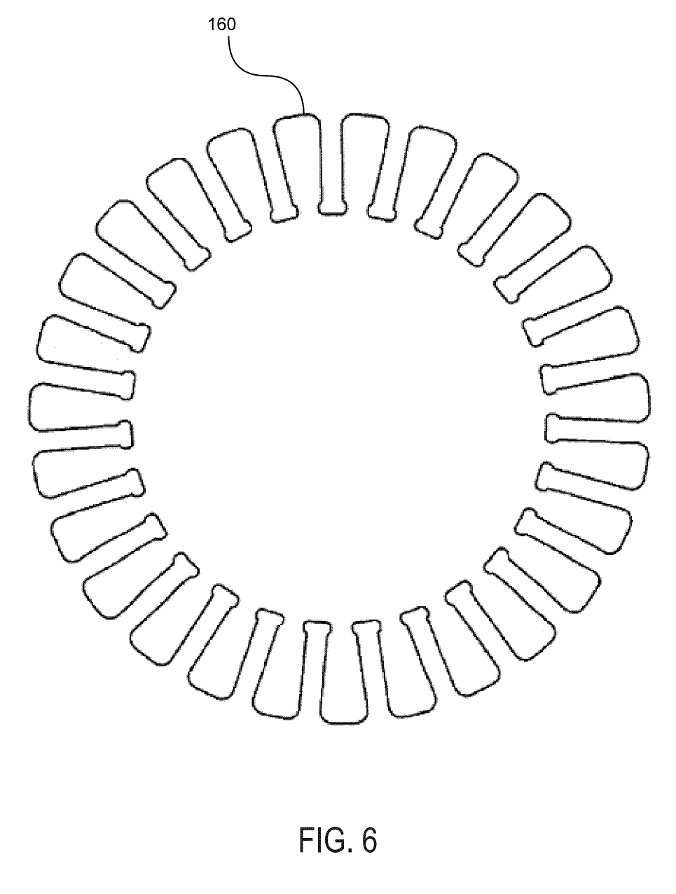

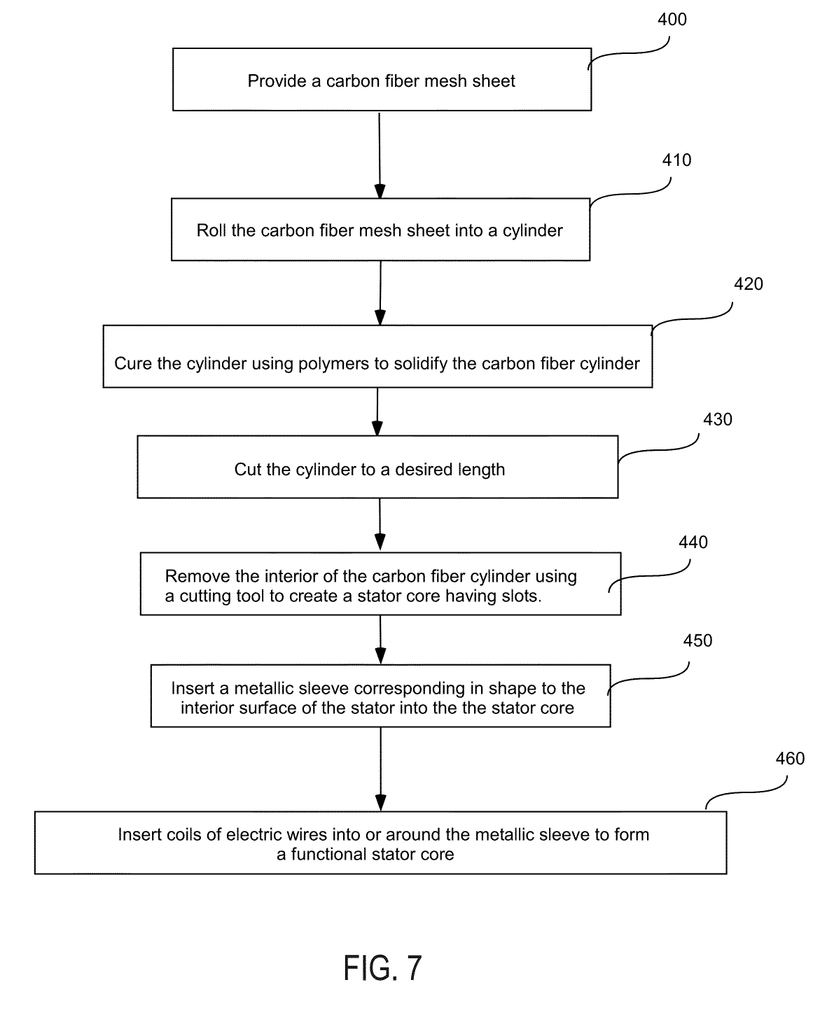

With regard to FIG. 7, carbon fiber may be utilized in the fabrication of the stator core in a first embodiment using the following steps. First, a woven carbon fiber sheet may be obtained in step 400, which sheet can then be rolled into a cylinder at 410. The cylinder can then be cured using polymers to solidify the carbon fiber cylinder into a permanent cylindrical shape at 420. The cylinder may then be cut to a desired stator core length at 430. Then a cutting tool, having a negative image of the interior of a stator core, as shown in FIG. 5, may be used to remove the central portion of the proposed stator core at 440. Subsequently a metal sleeve, as shown in FIG. 6 item 160, may be introduced into the slots or cavities of the carbon fiber stator core at 450. Finally wire windings may be introduced into cavities of the metallic sleeve or about the poles of the metallic sleeve as required for a specific type of motor in order to form a functional magnetic stator core at 460.

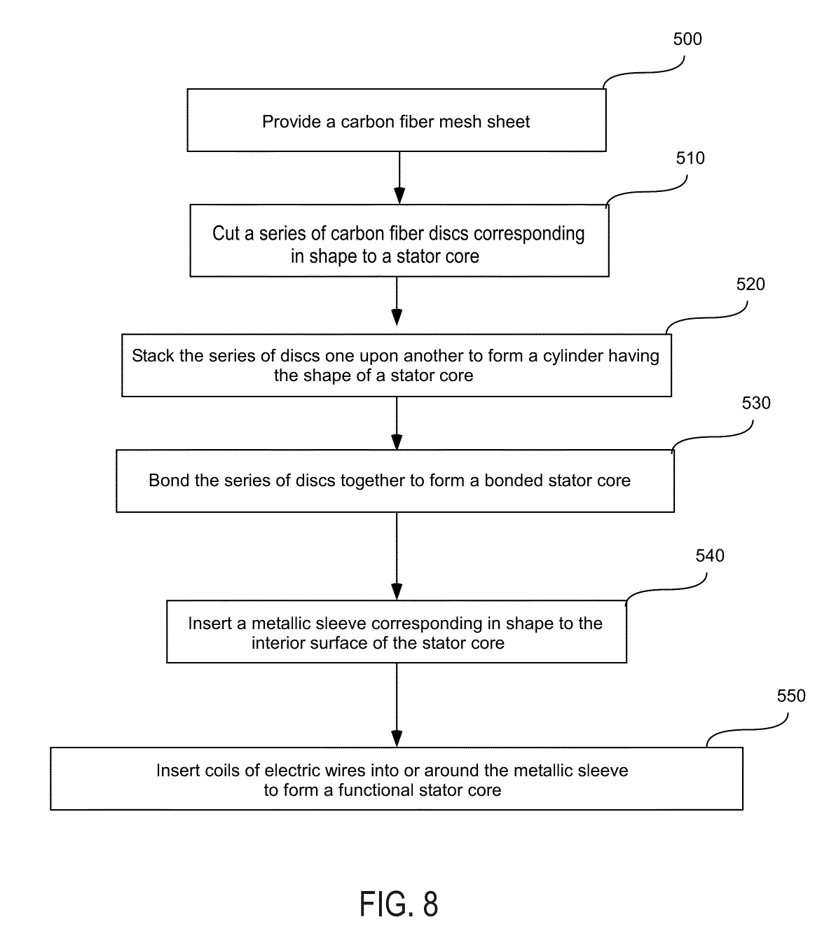

With regard to FIG. 8, an alternative fabrication method of a carbon fiber stator core 100 may be achieved via an alternative method as well. This method closely resembles the preceding method wherein a plurality of discs resembling the final shape of the stator core may be cut from a carbon fiber sheet and stacked one upon another and bonded together to form the stator core cylinder. Or in other words, it may be possible to manufacture a stator core using thin carbon fiber sheets similar to the standard methodology wherein a plurality of discs reflecting the stator slots may be cut of carbon fiber wafers rather than iron sheets and then stacked and bonded together.

This alternative method of fabricating a carbon fiber stator core can involve the following steps: a sheet of carbon fiber mesh can be provided at 500. Second, a series of carbon fiber discs corresponding in shape to a stator core can be cut at 510. Third, a series of discs can be stacked one upon another to form a cylinder having the shape of a stator core at 520. Fourth, the series of discs can be bound together to form a bonded stator core at 530. Fifth, a metallic sleeve, similar to sleeve 160 of FIG. 6, can be inserted into the interior surface of the stator core at 540. Sixth, coils of electric wires can be inserted into the slots or around the stator poles of the metallic sleeve to form a functional stator core at 550.

FIG. 5 represents a cutting tool 120 shown as a negative impression of a desired stator core shape which can be used to either bore out the cylinder of rolled carbon fiber of FIG. 7 into the stator core shape, or can be used as a punch to form an individual disc in the process of FIG. 8. This cutting tool may be formed of any suitable material for cutting, i.e. steel, aluminum, etc.

The a cutting, coring, or boring tool 120 may be utilized to provide slots for the wire coils of a permanent magnet type stator or alternatively poles around which wire may be coiled for an induction type motor. It should be appreciated that a similar cutting tool may be utilized for other motor type such as a stepper motor or a pancake design.

FIG. 6 represents a cross sectional view of a metallic sleeve 160 that can line the interior carbon surface of the stator core. The metallic sleeve serves to protect the stator core from the spinning rotor as well as providing a metallic substance which can be utilized to generate the electromagnetic fields necessary for motor function.

It should be appreciated that a particular advantage to using woven carbon fiber is that the long chain fibers of the carbon mesh of the carbon sheets may be configured to run vertically and horizontally throughout the sheet and can further be woven in specific directions to achieve various strength or magnetic field characteristics in the final stator core.

Another aspect of the present invention may be realized with respect to the use of carbon fiber in the rotor rather than the stator. This aspect of the invention relates to the use of a carbon fiber cylinder as the shaft rather than the traditional heavy metallic shaft, and the magnets or ferromagnetic metal bars traditionally required for an electric.

In traditional electric motors a metallic shaft is utilized and permanent magnets are affixed to it in the case of a permanent magnet motor or the shaft is formed of a ferromagnetic material and responds itself to the electromagnetic field as in and induction motor. However these shafts or cylinders can be extremely heavy and require large forces to spin due to their large inertial resistance. Applicant therefore proposes the use of carbon a carbon fiber rotor or shaft wherein magnets or metallic bars can either be affixed to or embedded into the carbon fiber shaft.

Additionally, it should be appreciated that other lightweight structural materials may be used in conjunction with the above recited methods such as plastics, polymers, and other composites such as fiberglass. Contemplated herein are also other fabrication methods commonly associate with such alternative lightweight structural materials such as three-dimensional printing or extrusion techniques. It should be appreciated that the carbon of the present invention may be substituted for any of these materials and associated fabrication methods

With respect to FIGS. 4A-B shown are two carbon shafts 200A and 200B. FIG. 4A represents a rotor of a permanent magnet rotor having a carbon shaft 200A wherein magnets 220 may be either affixed to the exterior surface of the shaft 200A or embedded within a circumference of the shaft 200A. Alternatively FIG. 4B illustrates a carbon shaft 200B having ferromagnetic rods 230 embedded within the circumferential surface of the rod 200B.

Within the cylindrical carbon fiber shaft the metal bars or magnets can be placed at either ⅔ radii or at another configuration. The use of carbon fiber as well as the incorporation of the above discussed t-bar design provides a smoothing out of the air gap, thus decreasing air turbulence increase the efficiency of the motor. By reducing the weight of the rotor and increasing swept area of the carbon fiber magnetic motor, the efficiency increases because the power needed to operate the motor are reduced because the kinetic energy required to spin the rotor are also reduced.

It should be recognized that either magnets may be embedded within the outer circumferential surface of the shaft as in FIG. 4B, as well as ferromagnetic material may also be affixed to the outer surface of the shaft as in FIG. 4A.

Additionally the shafts or magnets may be retained on or within the circumferential surface of the carbon shaft via adhesion or any other suitable method such as adding an additional thin carbon or Kevlar mesh over the magnet of the ferromagnetic component.

The system of the present invention allows for the fabrication of a motor which realizes numerous advantages. First, a 90% decrease in weight, as realized by the present invention over an iron setup, requires less energy to operate. Second, reduction of turbulence increases operating RPM. Third, an increased swept area increases power output. Fourth, a decrease in weight reduces ancillary friction loads in auxiliary components, such as bearings, and thereby increases efficiency. Fifth, a decrease of operational power reduces the operating temperature and thereby reduces energy inefficiencies realized through heat loss. Sixth an increased swept area requires less operational space, for same operational output thereby providing an increased power to weight ratio.

While the forgoing examples are illustrative of the principles of the present invention in one or more particular applications, it will be apparent to those of ordinary skill in the art that numerous modifications in form, usage and details of implementation can be made without the exercise of inventive faculty, and without departing from the principles and concepts of the invention. Accordingly, it is not intended that the invention be limited, except as by the claims set forth below.

1. An electric motor, comprising:
a carbon fiber stator core having a plurality of longitudinal slots and poles arranged on an interior surface thereof, the stator core having a hollow central portion;
a thin metallic sleeve inserted into the stator core so as to mate with an interior surface of the stator core, an outer surface of the metallic sleeve corresponding in shape to the interior surface of the stator core; and
a carbon fiber rotor suspended within the hollow central portion of the stator core, the carbon fiber rotor further comprising:
inserts formed of ferromagnetic metals or permanent magnets.

2. A motor in accordance with claim 1, further comprising:
a plurality of t-bars corresponding in shape to the longitudinal slots of the carbon fiber stator, the t-bars configured to mate with and fit within the longitudinal slots and create a smooth interior surface of the stator.

3. A method for forming an electrical motor having carbon fiber components comprising:
providing a carbon fiber mesh sheet;
rolling the carbon fiber mesh sheet into a carbon fiber cylinder;
curing the carbon fiber cylinder to solidify the carbon fiber cylinder into a shape;
cutting the carbon fiber cylinder to a desired length;
removing a central portion of the carbon fiber cylinder to form a stator core having a plurality of stator poles and stator slots;
inserting one or more metallic sleeves corresponding in shape to the stator slots into an interior surface of the stator slots; and
inserting coils of conductive wire through the stator slots.

4. The method of claim 3, further comprising:
inserting a plurality of t-bars corresponding in shape to the longitudinal slots of the carbon fiber stator, the t-bars configured to mate with and fit within the longitudinal slots and create a smooth interior surface of the stator.

5. The method of claim 3, further comprising:
inserting a rotor having a carbon fiber shaft having permanent magnets embedded within a circumferential surface of the carbon fiber shaft into the central portion of the stator core.

6. The method of claim 3, further comprising:
inserting a rotor having a carbon fiber shaft having ferromagnetic bars embedded within a circumferential surface of the carbon fiber shaft into the central portion of the stator core.

7. A method for forming an electric motor having carbon fiber components comprising:
providing a carbon fiber mesh sheet;
cutting a series of carbon fiber mesh discs corresponding in shape to a stator core;
stacking the series of carbon fiber mesh discs one upon another to form a cylinder having the shape of a stator core;
bonding the series of carbon fiber mesh discs together to form a bonded stator core;
inserting a metallic sleeve corresponding in shape to an interior surface of the bonded stator core;
winding coils of electric wires within the metallic sleeve to form a functional stator core.

8. The method of claim 7, further comprising:
inserting a rotor having a carbon fiber shaft having permanent magnets embedded within a circumferential surface of the carbon fiber shaft into the central portion of the stator core.

9. The method of claim 3, further comprising:
inserting a rotor having a carbon fiber shaft having ferromagnetic bars embedded within a circumferential surface of the carbon fiber shaft into the central portion of the stator core.
